(19) United States
(12) Patent Application Publication
(10) Pub. No.: US 2017/0197246 A1
(43) Pub. Date: Jul. 13, 2017

(54) METHOD FOR PRODUCING A COMPONENT FROM A METAL ALLOY WITH AN AMORPHOUS PHASE

(71) Applicant: HERAEUS HOLDING GMBH, Hanau (DE)

(72) Inventors: Jurgen Wachter, Rodermark (DE); Alexander Elsen, Limburg (DE); Annette Lukas, Rodenbach (DE)

(21) Appl. No.: 15/326,346

(22) PCT Filed: Jun. 19, 2015
(86) PCT No.: PCT/EP2015/063848

§ 371 Date: Jan. 13, 2017

(30) Foreign Application Priority Data
Jul. 15, 2014 (EP) 14177072.7

(51) Int. Cl. B22F 3/00; B22F 1/00; B22F 9/08; C22C 16/00; B23K 15/00; B33Y 70/00; B22F 3/105; C22C 1/04; C22C 45/10; B23K 26/342; B22F 3/15; B33Y 10/00

(52) U.S. Cl. CPC B22F 3/006; B22F 3/15; B22F 1/0048; B22F 9/082; C22C 16/00; B33Y 10/00; B33Y 70/00; B22F 3/1055; C22C 1/0458; C22C 45/10; B23K 26/342; B23K 15/0086; B22F 2009/0844; C22C 2200/02

(57) ABSTRACT

The invention relates to a method for producing a component from an at least partially amorphous metal alloy, comprising the following steps: providing a powder from an at least partially amorphous metal alloy; producing a shaped semi-finished product from the powder in that the powder is applied in layers and the powder particles of each newly applied layer, at least at the surface of the semi-finished product to be shaped, are fused and/or melted by targeted local heat input and bond to one another as they cool again; and hot pressing the semi-finished product, wherein the hot pressing is performed at a temperature that is between the transformation temperature and the crystallisation temperature of the amorphous phase of the metal alloy, wherein a mechanical pressure is exerted onto the semi-finished product during the hot pressing and the semi-finished product is compacted during the hot pressing.

The invention also relates to a component produced by such a method from a powder formed from an at least partially amorphous metal alloy and to the use of such a component as a gearwheel, friction wheel, wear-resistant component, housing, watch case, part of a gear unit, or semi-finished product.

The invention relates to a method for producing a component from an at least partially amorphous metal alloy.

The invention also relates to a component formed from a metal alloy with amorphous phase and to the use of such a component.

Amorphous metals and alloys thereof have been known for a number of decades. Such amorphous metallic alloys, which are also referred to as bulk metallic glasses or BMGs, can be produced by rapid solidification of a melt formed from two or more elements. With cooling rates of up to 10⁶ K/s, the material cannot form into regular crystalline structures; the natural crystallisation is suppressed and the molten state is “frozen”. From a metallographic viewpoint, a near order exits, but not a far order.

These materials produced in this way constitute a new material class having several advantages. Besides a high hardness and strength, amorphous metals are particularly resistant to corrosion and demonstrate advantageous magnetic properties compared with crystalline variants.

Due to the quick necessary cooling rates, however, the low thermal conductivity limits the maximum producible size of semi-finished products formed from amorphous metals to a few millimetres in diameter. With greater thicknesses the heat cannot be removed quickly enough from the interior of the material, and the crystallisation therefore cannot be suppressed. The small semi-finished product size thus limits the attainable component size.

Thin strips and production thereof are described for example in the disclosure DE 35 24 018 A1, wherein a thin metallic glass is produced on a carrier by quench-cooling from the melt phase. For example, a composite formed from an amorphous alloy is also described in patent document EP 2 430 205 B1 and, for production thereof, requires a cooling rate of 10² K/s. A disadvantage here is that only thin layers or very compact components a few millimetres in cross section can be constructed with such known methods.

One problem thus lies in producing large components in complex shapes and having an amorphous structure. The necessary cooling rates cannot be achieved technologically for complex components and semi-finished products of large volume. WO 2008/039134 A1 discloses a method in which a larger component is produced from an amorphous metal powder. For this purpose the component is constructed in layers in the manner of a 3D print, wherein partial regions of the layers are melted using an electron beam.

A disadvantage here is that the method can be implemented only in a very complex and costly manner. In addition, it is not possible to achieve sufficient homogeneity of the physical properties of the produced component by means of such a method. In order to enable a stable bonding of the amorphous metal powder, the powder must be melted locally using the electron beam. Due to the heat input with local melting and re-cooling of the powder close to the surface, the crystallisation temperature in the deeper layers already solidified amorphously may be exceeded at certain points, and the alloy may crystallise. This results in an undesirable quantity and a non-uniform distribution of crystalline phase in the component. In addition, the method lasts for a relatively long time, since it must be ensured that all regions influenced by the electron beam melt to a sufficient extent. The period of time for which the electron beam resides at one location of the powder, and therefore the temperature, must be set very accurately here.

One object of the invention thus lies in overcoming the disadvantages of the prior art. In particular, a method that can be implemented easily and economically is to be developed, with which a component can be produced from a metal alloy with amorphous content, which component can have a volume of 0.1 cm³ and more, preferably 1 cm³ and more, and can be produced in different shapes, including complex shapes. The produced component is also to have the highest possible homogeneity with regard to the physical properties and the distribution of the amorphous phase. Another object of the present invention is to provide such a component. The method should be variable and should deliver well reproducible results. The produced component should have the highest possible content of amorphous metallic phase. It is also desirable when the produced component is as compact as possible and has only few pores. A further object can be considered that of ensuring that the method can be implemented with the greatest possible number of different alloys able to form an amorphous phase. It is also advantageous when the method can be implemented using the simplest possible equipment and tools usually present in a laboratory.

The objects of the invention are achieved by a method for producing a component from an at least partially amorphous metal alloy, said method comprising the following steps:
1) providing a powder from an at least partially amorphous metal alloy, wherein the powder consists of spherical powder particles;
2) producing a shaped semi-finished product from the powder in that the powder is applied in layers and the powder particles of each newly applied layer, at least at the surface of the semi-finished product to be shaped, are fused and/or melted by targeted local heat input and bond to one another as they cool again; and
3) hot pressing the semi-finished product, wherein the hot pressing is performed at a temperature that is between the transformation temperature and the crystallisation temperature of the amorphous phase of the metal alloy, wherein a mechanical pressure is exerted onto the semi-finished product during the hot pressing and the semi-finished product is compacted during the hot pressing.

The semi-finished product during production is preferably fused and/or melted, over the entire surface of the semi-finished product to be shaped, by targeted local heat input. This is preferably achieved in that the powder particles of each newly applied layer are fused and/or melted, at least at the surface of the semi-finished product to be shaped, by targeted local heat input.

The duration of the hot pressing is preferably selected in such a way that the duration is at least long enough for the powder to be sintered after the hot pressing, and the duration is at most long enough for the semi-finished product to still have an amorphous content of at least 85 percent after the hot pressing.

Since the powder particles are not all the same size and since, even if the powder particles were all the same size, the local heat input is not provided entirely homogeneously, it may be that some powder particles are completely melted, some are fused only at the surface thereof, and further powder particles remain solid or at best become soft.

In physics and chemistry an amorphous material is a substance in which the atoms do not have ordered structures, but form an irregular pattern and have only close order, but not far order. In contrast to amorphous materials, regularly structured materials are referred to as crystalline.

In the case of hot pressing the powder particles become soft at the surface and bond to one another and remain bonded after cooling. A cohesive body or a cohesive semi-finished product is thus produced from the powder. In accordance with a preferred embodiment of the present invention the semi-finished product after hot pressing has a density of at least 97% of the theoretical density of the fully amorphous metal alloy.

The combination of pressure and temperature treatment during the hot pressing results in a more compact semi-finished product. In addition, the bonding of the powder particles to one another is improved by the plastic deformation, such that a shorter duration of the temperature treatment can be selected and the content of crystalline phase in the component is reduced.

The transformation temperature of an amorphous phase is often also referred to as the glass transition temperature or as the transformation point or glass transition point, wherein it should be clarified here that these are equivalent terms for the transformation temperature.

It is proposed with the present invention that the hot pressing of the semi-finished product is carried out by a hot isostatic pressing of the semi-finished product, and the semi-finished product is preferably compacted by hot isostatic pressing.

Hot isostatic pressing (HIP) has the advantage that even components shaped in a complex manner can be produced using the method. Here, a uniform or shape-accurate shrinkage of the semi-finished product takes place, such that the relative dimensions are maintained.

The heating until the transformation temperature is reached and the cooling during the hot pressing should be performed as quickly as possible in accordance with the invention since the mandatorily present seed crystals also crystallise at these temperatures below the transformation temperature, but no softening of the powder particles is achieved yet which could lead to a bonding and a compaction of the powder. In accordance with the invention a plastic deformation of the powder particles should be achieved, which leads to a compacting of the powder and therefore to an accelerated bonding of the powder. An overshoot of the temperature above the desired target temperature or end temperature should be as low as possible here.

It is also proposed with the invention, as a preferred embodiment of the method, that the hot pressing is performed under vacuum, wherein the semi-finished product is preferably compacted by hot pressing under a vacuum of at least 10⁻³ mbar.

As a result of the application of a vacuum of this type, the formation of oxides or other reaction products with air can be reduced. These foreign substances are not only themselves bothersome, but additionally promote the formation of an undesirable crystalline phase in the semi-finished product during the hot pressing.

For the same reason the hot pressing may additionally or also alternatively take place under an inert gas in accordance with the invention, in particular under a noble gas, such as argon, preferably with a purity of at least 99.99%, particularly preferably with a purity of at least 99.999%. In accordance with such embodiments the atmosphere in which the hot pressing is performed may preferably be largely freed from residual gases by repeated evacuation and flushing with noble gas, in particular with argon.

In accordance with the invention the hot pressing may also alternatively be performed under a reducing gas, in particular under a forming gas, in order to minimise the quantity of bothersome metal oxides.

A further measure for reducing the number of metal oxides in the component or in the semi-finished product can be achieved by the use of an oxygen getter during the hot pressing of the powder and/or during the production of the powder.

In accordance with a preferred variant of the method according to the invention, the shaped semi-finished product is produced from the powder using an additive manufacturing method, in particular a 3D printing method.

A high variability in the shape of the component to be produced is thus made possible. At the same time, modern CAM methods can be used effectively and easily in this way.

In accordance with preferred methods the targeted local heat input into the powder particles of each newly applied layer can also be performed using an electron beam or a laser beam, preferably using a controlled electron beam or a controlled laser beam.

The use of an electron beam is preferred in accordance with the invention compared with a laser beam, since the electron beam and therefore the heating of the powder particles or of the powder can be achieved significantly more accurately and more quickly with the electron beam. The electron beam can be controlled more easily and therefore can be used more accurately. A laser beam must be oriented via tiltable mirrors, whereas an electron beam can be easily deflected via magnetic fields or electrical fields and therefore can be oriented very quickly. This has the advantage that the heat input can be controlled much more accurately.

In accordance with a development of the method according to the invention it is proposed for the powder particles of the component to be produced to be fused in each newly applied layer in at least 90% of the area of the newly applied layer by selective local heat input, preferably in at least 95% of the area of the newly applied layer, particularly preferably in at least 99% of the area of the component to be produced in the newly applied layer.

The method is thus indeed more complex, but the produced component at the same time is more homogeneous. Components produced in this way are particularly well suited for certain applications in which a high homogeneity of the components or of the physical properties of the components is of particular importance.

The powder consists of spherical powder particles.

The powder particles may also have a diameter smaller than 125 μm.

The powder preferably consists of powder particles of which 100% have a diameter smaller than 125 μm. Such particles sizes or particle distributions are often also referred to by D₁₀₀=125 μm.

Spherical particles in the sense of the present invention do not have to be geometrically perfect spheres, but may also deviate from the sphere shape. Preferred spherical powder particles have a rounded at least approximately spherical shape and have a ratio of the longest cross section to the shortest cross section of at most 2 to 1. In the sense of the present invention a spherical geometry therefore does not mean a strictly geometrical or mathematical sphere. The cross sections here relate to extreme dimensions extending within the powder particles. Particularly preferred spherical powder particles may have a ratio of the longest cross section to the shortest cross section of at most 1.5 to 1 or even more preferably may be spherical. Here, the greatest cross section of the powder particles is taken as diameter in accordance with the invention.

The spherical shape of the powder particles has the following advantages:
The spherical particles form a flowable powder, which is helpful in particular in the case of processing in layers via powder tanks and doctor blades;
A high bulk density of the powder can be achieved;
The powder particles have similarly curved surfaces, which become soft during the hot pressing under identical conditions (temperature and time and/or the same heat energy input)—or at least become soft in a good approximation of identical conditions. These particles thus bond particularly well with adjacent powder particles during the hot pressing, moreover within a short period of time, or at a previously known moment in time, or within a previously known time interval. A further advantage of a high bulk density is a low shrinkage of the pre-finished product during the hot pressing. Near net shape manufacture is thus possible.

The powder particle size of the powder or the powder particle size distribution of the powder can be achieved by the production process and by screening a starting powder. The powder provided in accordance with the invention is thus produced by screening a starting powder before it is provided or used for the method according to the invention. This is the case unless the starting powder already has the desired properties already after the production process. In addition, it can also be ensured by means of screening that the number of powder particles with a shape deviating significantly from the spherical shape, created by sintering a number of powder particles (what is known as satellite formation), and contained in the starting powder can be reduced or minimised

In accordance with a development of the invention the duration of the hot pressing can also be selected in such a way that the powder particles are bonded to one another after the hot pressing and the produced component has an amorphous content of at least 85 percent, preferably of more than 90 percent, particularly preferably of more than 95 percent, even more preferably of more than 98 percent.

The higher the content of the amorphous phase in the semi-finished product, the more closely approximated are the desired physical properties of a semi-finished product consisting completely of amorphous phase.

In accordance with preferred embodiments of the present invention, a powder formed from an amorphous metal alloy containing at least 50 percent by weight zirconium can also be used as powder.

Zirconium-containing amorphous metal alloys are particularly well suited for the implementation of methods according to the invention, since in many of these alloys there is a great difference between the transformation temperature and the crystallisation temperature, whereby the method can be implemented more easily.

In accordance with especially preferred embodiments of the present invention a powder formed from an amorphous metal alloy comprising
a) 58 to 77 percent by weight zirconium,
b) 0 to 3 percent by weight hafnium,
c) 20 to 30 percent by weight copper,
d) 2 to 6 percent by weight aluminium, and
e) 1 to 3 percent by weight niobium
   can be provided as powder.

Here, a powder formed from an amorphous metal alloy consisting of
a) 58 to 77 percent by weight zirconium,
b) 0 to 3 percent by weight hafnium,
c) 20 to 30 percent by weight copper,
d) 2 to 6 percent by weight aluminium, and
e) 1 to 3 percent by weight niobium
   can preferably be provided as powder.

Here, the sum of the chemical elements preferably gives 100%. Zirconium is then contained as remainder.

The remaining content up to 100 percent by weight is zirconium in this case. Conventional impurities may be contained in the alloy. These zirconium-containing amorphous metal alloys are especially well suited to the implementation of methods according to the invention.

Furthermore, the powder may be produced by atomizing, preferably by atomizing in a noble gas, in particular in argon, particularly preferably by atomizing in a noble gas of purity 99.99%, 99.999%, or a higher purity. Within the scope of the present invention, reference is then also made to an amorphous metal alloy when the metal alloy has a content of amorphous phase of at least 85 volume percent.

The powder is of course produced prior to the provision of the powder. Powder particles of spherical shape can be produced easily and economically by atomizing. The use of noble gas, in particular of argon or highly pure argon during the atomizing means that as few bothersome impurities as possible, such as metal oxides, are contained in the powder.

In accordance with a development of the present invention, the powder may also comprise less than 1 percent by weight of particles with a diameter smaller than 5 μm, or the powder is screened or treated by air classification, such that it comprises less than 1 percent by weight of particles with a diameter smaller than 5 μm.

Powder particles with a diameter smaller than 5 μm are preferably removed by air classification in accordance with the invention, or more specifically the content of powder particles with a diameter smaller than 5 μm is reduced by air classification.

Due to the low content of powder particles with a diameter smaller than 5 μm, the surface of the powder (sum of the surfaces of all powder particles) sensitive to oxidation or to another interfering chemical reaction of the powder particles with surrounding gas is limited. Furthermore, by limiting the particle size of the powder, it is ensured that the softening of the powder particles will take place under similar conditions (in view of temperature and time and/or the performed energy input), since the curvatures of the surfaces and volumes of the powder particles are then similar, and a compact filling of the powder by pressing can thus be achieved. A low content of fine powder particles (smaller than 5 μm) does not have a disadvantageous effect, since such powder particles can settle in the gaps between larger particles and thus increase the density of the unsintered powder. However, an excessively high quantity of fine powder particles can have a disadvantageous effect on the flowability of the powder, and these are therefore preferably removed. The fine (small) powder particles specifically tend to agglomerate with larger particles.

It is proposed in accordance with a preferred development of the method according to the invention that the hot pressing of the powder is performed at a temperature (T) between the transformation temperature (T_{T}) and a maximum temperature, wherein the maximum temperature lies above the transformation temperature (T_{T}) by 30% of the temperature difference between the transformation temperature (T_{T}) and the crystallisation temperature (T_{K}) of the amorphous phase of the metallic alloy, wherein the maximum temperature preferably lies above the transformation temperature (T_{T}) by 20% or 10% of the temperature difference between the transformation temperature (T_{T}) and the crystallisation temperature (T_{K}) of the amorphous phase of the metallic alloy.

When the hot pressing is performed close to or above the transformation temperature (T_{T}), the creation and the growth of crystalline phase is relatively low and therefore the purity of the amorphous phase (the content of the amorphous phase) in the component is high. Expressed as a formula, the temperature T at which the hot pressing of the powder is performed, based on the transformation temperature T_{T} and the crystallisation temperature T_{K} of the amorphous phase of the metal alloy, should meet the following conditions:

T_{T}<T<T_{T}+(30/100)*(T_{K}−T_{T}) or

preferably T_{T}<T<T_{T}+(20/100)*(T_{K}−T_{T}) or

particularly preferably T_{T}<T<T_{T}+(10/100)*(T_{K}−T_{T}).

With the temperature ranges specified in the above mathematical formulas, in which ranges the hot pressing is to take place, a bonding of the powder particles and a compaction of the semi-finished product with low formation of crystalline phases in the semi-finished product or the produced component is achieved.

A particularly advantageous embodiment of methods according to the invention is provided when the duration of the hot pressing is selected depending on the geometric shape, in particular the thickness, of the semi-finished product, and preferably is selected depending on the largest relevant diameter of the semi-finished product.

The geometric shape, or the thickness, of the semi-finished product is taken into consideration to the extent that the heat conduction into the shaped powder or into the shaped semi-finished product should be sufficient to also heat the powder within the semi-finished product or to heat the semi-finished product internally to the transformation temperature or to above the transformation temperature, such that the powder within the semi-finished product is also softened and compacted.

The largest relevant diameter of the semi-finished product can be determined geometrically by the largest sphere that can be accommodated geometrically within the shaped semi-finished product. When determining the largest relevant diameter, channels or gaps in the body can be disregarded, which do not contribute to the heat input via a surrounding gas and/or another heat source or only contribute to this heat input to a small extent (for example in the sum of less than 5%).

The duration of the hot pressing may preferably lie in a time range of 3 seconds per millimetre of the thickness or of the greatest relevant diameter of the semi-finished product to 900 seconds per millimetre of the thickness or of the greatest relevant diameter of the semi-finished product, wherein the duration of the hot pressing preferably lies in a time range from 5 seconds per millimetre of the thickness or of the greatest relevant diameter of the semi-finished product to 600 seconds per millimetre of the thickness or of the greatest relevant diameter of the semi-finished product.

By taking into consideration the shape, the thickness, or the wall thickness of the semi-finished product, and/or the greatest relevant diameter of the semi-finished product, the duration of the hot pressing is selected such that there is sufficient compaction of the powder and bonding of the powder particles, but at the same time the formation of crystalline phase in the semi-finished product is kept as low as possible or ideally is minimal. For certain components and for some applications, it may already be sufficient if only the edge regions of the component are completely compacted and powder that has not yet been bonded or compacted is present in the interior of the component. However, the component is preferably also compacted in the interior.

In accordance with a preferred embodiment of the present invention the powder particles can be plastically deformed by the hot pressing.

A particularly good compaction of the powder alongside low production of crystalline phase is thus achieved.

In a particularly preferred embodiment of the invention the powder particles in an inner part of a newly applied layer are not or are only partly fused and/or melted.

By this the method, preferably the 3D-print, can be conducted faster and further the component obtained contains less crystalline phase. Here it is taken advantage of the effect that it is sufficient to first stabilize the surface of the shaped semi-finished product by connecting the powder particles, whereby the inner parts of the component are later also connected by the following hot pressing.

The objects forming the basis of the present invention are also achieved by a component produced by means of such a method from a powder formed from an at least partially amorphous metal alloy.

The objects forming the basis of the invention are also achieved by the use of such a component as a gearwheel, friction wheel, wear-resistant component, housing, watch case, part of a gear unit, or semi-finished product.

The invention is based on the surprising finding that, by hot pressing the semi-finished product after constructing the semi-finished product in layers, it is possible to keep the local heat input very low during the construction in layers. It is sufficient when the powder is fused and/or melted in the region of the surface of the shape to be produced or of the shaped semi-finished product, so that the produced semi-finished product is stable enough that it does not disintegrate on its own. Due to the low local heat input and the rapid cooling of the heated regions, only a low quantity of crystalline phase can be produced in the semi-finished product. The compaction is performed subsequently by the hot pressing of the semi-finished product. In the event of the compaction during the hot pressing, the temperature can be set much more accurately, such that the formation and growth of crystalline phase can be kept low.

For the invention, use is made of the fact that the viscosity of amorphous alloys drops significantly when the glass transition temperature T_{G} (synonymous with transformation temperature T_{T}) is exceeded, whereby these alloys can be shaped. By means of thermoplastic shaping methods, amorphous alloys can then be compacted into any shape under mechanical pressure.

It has been found within the scope of the present invention that methods according to the invention lead to particularly good results when the amorphous metal powders for producing the component are produced via atomizing and the powders are X-ray amorphous, wherein the powder particles thereof are preferably smaller than 125 μm. The fine particles contain only a very low quantity of heat, which has to be removed in order to allow the particles to solidify amorphously. Since the focus of an electron beam lies considerably above the particle size, a number of particles are always melted simultaneously with the use of an electron beam. The upper limit of the particle size prevents that such particles, which have a larger cross section than the layers produced, if being removed by a doctor blade, thus making the layer incomplete. In the case of atomizing, the produced molten droplets of the alloy are cooled very quickly by the process gas flow (argon), whereby the presence of an amorphous powder fraction is required. In accordance with a further development of the invention the fine dust (particles smaller than 5 μm) and also the coarse grain greater than 125 μm are largely separated from this powder, for example are removed by screening and/or by air classification of the powder. Starch powder fractions are then an optimal starting material (the provided powder) for producing complex amorphous components by local fusion and/or melting and subsequent hot pressing. With powders produced in this way, a component having a particularly high content of amorphous metallic phase is obtained. At the same time, the component thus created and produced from a powder of this type has a high degree of sintered powder particles and a low porosity, preferably a porosity of less than 5%.

These amorphous metal powders are processed in accordance with the invention by means of generative methods to form any semi-finished products for components. Since only thin powder layers are always melted, the quantity of heat to be removed here is low enough to construct the individual layers—and therefore the semi-finished product as a whole—amorphously.

A particularly suitable method is provided by what is known as (selective) electron beam melting: Here, a thin powder layer, which is applied to a carrier plate by means of a doctor blade is melted—in a targeted manner by a high-energy and precisely controllable electron beam. Due to the high energy density of the electron beam compared to similar methods, which for example use laser beams as energy source, the uppermost layer of the powder is heated in a locally very limited manner, and there is only a very low heat input into deeper layers. A subsequent crystallisation, when the crystallisation temperature is exceeded, of the deeper and already amorphously solidified material is thus effectively prevented.

This process can be shortened further in that the powder is not completely melted, but the powder particles are bonded only to the closest neighbouring particles. The amorphous semi-finished product is then compacted by hot pressing, preferably by hot isostatic pressing (HIP) between the glass transition temperature T_{G} and crystallisation temperature T_{K} (or between the transformation temperature T_{T}(=T_{G}) and crystallisation temperature T_{K}).

Here, it is important that, during the subsequent hot pressing, the amorphous powder is not heated to the crystallisation temperature or above, since otherwise crystallisation occurs and the amorphous nature of the alloy is lost. On the other hand it is necessary to heat the material at least to the transformation temperature, i.e. the temperature at which the amorphous phase of the metal alloy transitions during cooling from the plastic range into the rigid state. In this temperature range the powder particles can bond to one another, but without crystallising. The transformation temperature may also be referred to as the glass transition temperature.

Since, however, it is technologically hardly possible and economically is not expedient to achieve absolute freedom from impurities and also freedom from oxygen in particular, microcrystalline inclusions cannot be avoided. Low oxygen contents in the two-digit ppm range cause corresponding oxide formation of the constituents of the alloy that have a high affinity for oxygen. These are then present as small crystallisation nuclei and can thus lead to small oxide inclusions with grains that in the microsection with 1000 times magnification or in an X-ray diffractometry examination can be identified as peaks. Similar effects can also be produced by further or other impurities of the starting materials and also further elements, such as nitrogen.

The duration of the hot pressing is dependent primarily on the component volume or the semi-finished product volume and generally should not last too long, since any crystal nucleus, however small, acts as seed crystal and crystallites may thus grow, or the undesired crystalline phase spreads in the semi-finished product. In tests with zirconium-based alloys it was possible to demonstrate that a temperature treatment during the hot pressing in the temperature range according to the invention with a duration of at most 400 seconds per 1 mm of semi-finished product cross section delivers particularly good results. The heating phase should also be performed as quickly as possible, since the undesired crystal growth sometimes occurs already at 50 Kelvin below the transformation temperature.

With the method according to the invention, finished amorphous components can thus be produced on the one hand, and on the other hand amorphous semi-finished products for further processing, for example for thermoplastic shaping, can be produced, of which the size is limited only by the working area of the used facilities.

Further exemplary embodiments of the invention will be explained hereinafter on the basis of a schematically illustrated flow diagram and on the basis of 3 figures, but without limiting the invention hereto. In the figures:

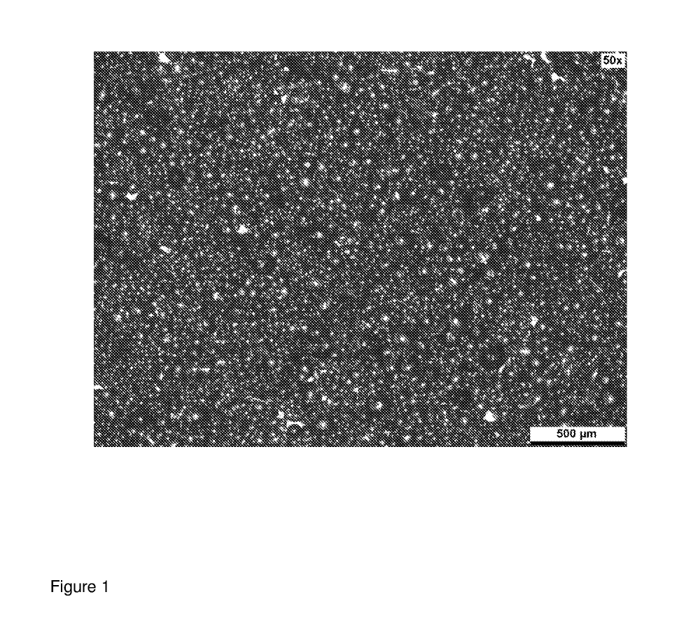

FIG. 1: shows and enlarged recorded image of a sintered powder melted using an electron beam and formed from an amorphous metal alloy with 50 times magnification;

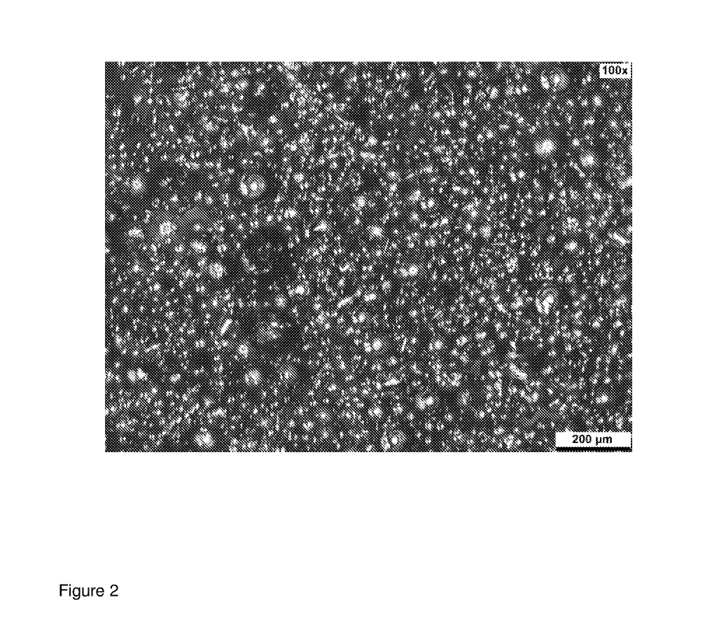

FIG. 2: shows an enlarged recorded image of a sintered powder melted using an electron beam and formed from an amorphous metal alloy with 200 times magnification; and

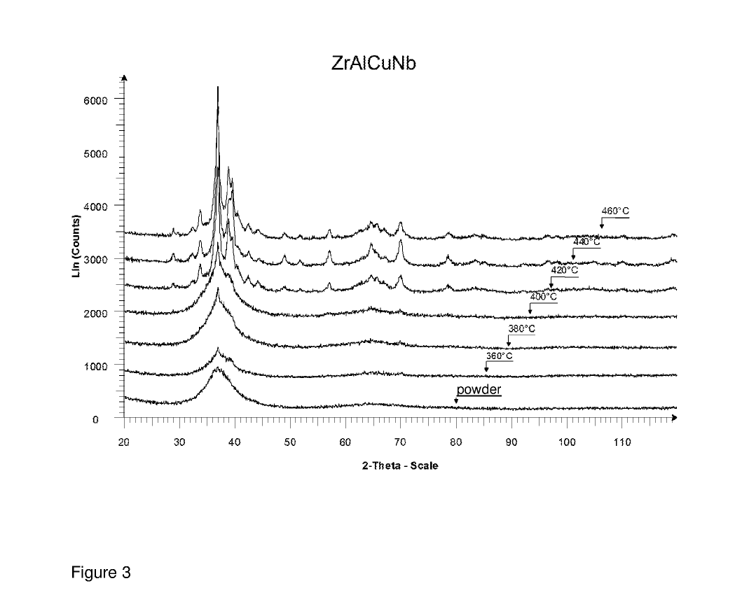

FIG. 3: shows multiple X-ray/powder diffractograms of an amorphous Zr—Al—Cu—Nb powder (lower curve) and amorphous Zr—Al—Cu—Nb powders, which were sintered at different temperatures.

In the flow diagram, T denotes the working temperature, T_{T} denotes the transformation temperature of the amorphous metal alloy, and T_{K} denotes the crystallisation temperature of the amorphous phase of the metal alloy.

An amorphous metallic powder is produced from a metallic alloy of which the composition is suitable for forming an amorphous phase or which already consists of the amorphous phase. Powder fractionation is then performed, in which case excessively small and excessively large powder particles are removed, in particular by screening. The powder is then processed by an additive manufacturing method to form a component of the desired geometry. The powder, which forms the external contour of the component, is completely melted and forms a tight, pore-free structure, whereas the powder in the volume of the component is merely sintered, in order to attain an adhesion of the powder particles to the closest neighbour.

The temperature treatment during the pressing or after the pressing is performed for a period of time of at most 10 min at a temperature above the transformation temperature T_{T} and below the crystallisation temperature T_{K} of the amorphous phase of the used metallic alloy.

Specific practical examples will now follow, in which methods according to the invention are described and in which the results thus obtained are evaluated.

### EXAMPLE 1

An alloy formed from 70.6 percent by weight of zirconium (Haines&Maassen Metallhandelsgesellschaft mbH Bonn, Zr-201 zirconium Crystalbar), 23.9 percent by weight copper (Alpha Aesar GmbH & Co KG Karlsruhe, Copper plate, Oxygen free, High Conductivity (OFCH) product number 45210), 3.7 percent by weight aluminium (Alpha Aesar GmbH & Co KG Karlsruhe, Aluminium Ingot 99.999% product number 10571) and 1.8 percent by weight niobium (Alpha Aesar GmbH & Co KG Karlsruhe, niobium film 99.97% product number 00238) was melted in an induction melting facility (VSG, inductively heated vacuum, melting and casting facility, Nürmont, Freiberg) under 800 mbar argon (Argon 6.0, Linde AG, Pullach) and poured into a water-cooled copper mould. A fine powder was produced from the alloy thus produced using a method as is known for example from WO 99/30858 A1 in a Nanoval atomizing apparatus (Nanoval GmbH & Co. KG, Berlin) by atomization of the melt with argon.

By separation by means of air classification using a Condux Ultra-Fine Classifier CFS (Netsch-Feinmahltechnik GmbH Selb Germany), the fine grain was separated, such that less than 0.1% of the particles were smaller than 5 μm, i.e. at least 99.9% of the particles had a cross section or a dimensioning of 5 μm or more, and all powder particles larger than 125 μm were removed by screening by means of an analysis screen with 125 μm mesh width (Retsch GmbH, Haan-Germany, product number 60.131.000125). The powder thus produced was examined by means of X-ray diffractometry and had an amorphous content of greater than 95%.

The powder thus produced was applied in layers in an EBM (electron beam melting) manufacturing facility (Arcam AB A1, Möndal, Sweden) without prior heating of the powder, wherein an electron beam with a power from 150 W to 210 W scanned the contour of the component and melted the powder particles. The individual layers thus solidified so quickly that crystallisation was suppressed and the alloy solidifies amorphously. For the sintering of the powder in the volume of the component, the electron beam was fanned out to 50 beams and directed in a planar manner over the powder bed. The energy was thus low enough that the individual powder particles did not melt, but adhered only to their closest neighbour. Recorded images of the powder sintered in this way taken using a microscope are shown in FIGS. 1 and 2.

During the entire process the temperature of the powder bed must be kept below the crystallisation temperature T_{K} of the alloy.

FIG. 3 shows X-ray/powder diffractograms of the starting powder and of powders that have been sintered at different temperatures.

The starting powder (lower curve) demonstrates no reflexes of crystalline phases, i.e. is completely amorphous.

At temperatures of 360° C., 380° C. and 400° C., only a few signs of crystallites were found, however these are not tolerable for the processability within the scope of the present invention. From a sintering temperature of 420° C., clear reflexes were visible, indicating a crystalline phase. The crystallisation temperature T_{K} was exceeded in this case and the sample crystallised out or crystallised too severely.

The components produced as described were then compacted by hot isostatic pressing at a pressure of 200 megapascal (200 MPa) under highly pure argon (Argon 6.0, Linde AG, Pullach) at a temperature of 400° C. for 300 seconds. The powder in the volume of the component was thus also completely compacted and forms a compact, pore-free body.

Fifteen components produced in this way were examined by means of metallographic microsection with regard to the amorphous area percentage in the structure. Here, it was found that on average 92% of the areas were amorphous.

### EXAMPLE 2

An alloy formed from 70.6 percent by weight zirconium (Haines&Maassen Metallhandelsgesellschaft mbH Bonn, Zr-201 zirconium Crystalbar), 23.9 percent by weight copper (Alpha Aesar GmbH & Co KG Karlsruhe, Copper plate, Oxygen free, High Conductivity (OFCH) product number 45210), 3.7 percent by weight aluminium (Alpha Aesar GmbH & Co KG Karlsruhe, Aluminium Ingot 99,999% product number 10571) and 1.8 percent by weight niobium (Alpha Aesar GmbH & Co KG Karlsruhe, niobium film 99.97% product number 00238) was melted in an induction melting facility (VSG, inductively heated vacuum, melting and casting facility, Nürmont, Freiberg) under 800 mbar argon (Argon 6.0, Linde AG, Pullach) and poured into a water-cooled copper mould. A fine powder was produced from the alloy thus produced using a method as is known for example from WO 99/30858 A1 in a Nanoval atomizing apparatus (Nanoval GmbH & Co. KG, Berlin) by atomization of the melt with argon.

By separation by means of air classification using a Condux Ultra-Fine Classifier CFS (Netsch-Feinmahltechnik GmbH Selb Germany), the fine grain was separated, such that less than 0.1% of the particles were smaller than 5 μm, i.e. at least 99.9% of the particles had a cross section or a dimensioning of 5 μm or more, and all powder particles larger than 125 μm were removed by screening by means of an analysis screen with 125 μm mesh width (Retsch GmbH, Haan-Germany, product number 60.131.000125). The powder thus produced was examined by means of X-ray diffractometry and had an amorphous content of greater than 95%.

The powder thus produced was applied in layers in an EBM (electron beam melting) manufacturing facility (Arcam AB A1, Möndal, Sweden) without prior heating of the powder, wherein an electron beam with a power from 150 W to 210 W scanned the contour of the component and melted the powder particles. The individual layers thus solidified so quickly that crystallisation was suppressed and the alloy solidified amorphously. For the sintering of the powder in the volume of the component, the electron beam was fanned out to 50 beams and directed in a planar manner over the powder bed. The energy was thus low enough that the individual powder particles did not melt, but adhered only to their closest neighbour. The temperature of the powder bed must be kept below the crystallisation temperature T_{K} of the alloy during the entire process.

The components produced as described were then compacted by pressing at a pressure of 200 megapascal (200 MPa) at a temperature of 400° C. for 180 seconds. The powder in the volume of the component was thus also completely compacted and forms a compact, pore-free body.

Ten components produced in this way were examined by means of metallographic microsection with regard to the amorphous area percentage in the structure. Here, it was found that on average 87% of the areas were amorphous .

The results measured for Examples 1 and 2 are presented in the following table in conjunction with a reference measurement:

| | Enthalpy of | | |
|---|---|---|---|
| | crystallisation | Crystallinity | Amorphicity |
| | J/g | % | % |
| Reference | −47.0 | 0 | 100 |
| Example 1 | −34.0 | 8 | 92 |
| Example 2 | −32.2 | 13 | 87 |

Test and Inspection Methods

1) Method for determining the particle size of metal alloy powders:

The particle size of inorganic powders was determined by laser light scattering using a Sympatec Helos BR/R3 (Sympatec GmbH), equipped with a RODOS/M dry disperser system with the vibratory feeding unit VIBRI (Sympatec GmbH). Sample volumes of at least 10 g were provided dry, dispersed at a primary pressure of 1 bar, and the measurement was started. An optical concentration of 1.9% to 2.1% was used as starting criterion. The measurement time was 10 seconds. The evaluation was performed in accordance with the MIE theory, and the d50 was used as a measure for the particle size.

2) Inspection method for determining the density:

To determine the density a geometrically exact cuboid was produced by grinding of the surfaces, such that this could be measured exactly using a digital outside micrometer (PR1367, Mitutoyo Messgeräte Leonberg GmbH, Leonberg). The volume was then determined mathematically. The exact weight was then determined on an analytical balance (XPE analytical balance from Mettler-Toledo GmbH). The density was given by forming the ratio of weighed weight and calculated volume.

The theoretical density of an amorphous alloy corresponds to the density at the melting point.

3) Inspection method for determining the amorphous area percentage in the component:

For this purpose fifteen metallographic polished sections were produced in accordance with DIN EN ISO 1463 (as valid at date May 26, 2014), wherein polishing was performed using an SiC film 1200 (Struers GmbH, Willich) and by subsequent polishing steps using diamond polishing means with 6 μm, 3 μm and 1 μm (Struers GmbH, Willich), and lastly with the chemo-mechanical oxide polishing suspensions OP-S (Struers GmbH, Willich). The polished surfaces thus produced were examined under a light microscope (Leica DM 4000 M, Leica DM 6000 M) with a magnification of 1000 for crystalline area percentages in the microsection. An evaluation of area percent crystalline proportion to total area of the polished section was made in this regard using the software Leica Phase Expert, wherein the dark regions were assessed as crystalline and the light regions were assessed as amorphous. The amorphous matrix was for this purpose defined as reference phase and was expressed as percentage of the total measured area. 10 different sample areas were measured and averaged.

4) Inspection method for determining the conversion temperatures:

A Netzsch DSC 404 F1 Pegasus calorimeter (Erich NETZSCH GmbH & Co. Holding KG) equipped with a high-temperature tube furnace with Rh meander heater, an integrated control thermocouple type S, DSC404F1A72 sample carrier system, crucible made of Al₂O₃ with cover, an OTS system for removing traces of oxygen during the measurement including three getter rings and an evacuation system for automatic operation with two-stage rotary pump was used here. All measurements were taken under inert gas (Argon 6.0, Linde AG) with a throughflow rate of 50 ml/min. The evaluation was performed using the software Proteus 6.1. To determine the TT, the tangent method (“glass transition”) was used in the range between 380° C. and 420° C. (Onset, Mid, Inflection, End). In order to determine the TK, the “complex peak” evaluation was used in the temperature range 450-500° C. (Area, Peak, Onset, End, Width, Height), and for Tm the “complex peak” evaluation was used in the temperature range 875-930° C. (Area, Peak, Onset, End, Width, Height). In order to take the measurement, 25 mg+/−0.5 mg sample were weighed into the crucible, and the measurement was taken at the following heating rates and temperature ranges.

20-375° C.: heating rate 20 K/min
375-500° C.: heating rate 1 K/min
500-850° C.: heating rate 20 K/min
above 850° C.: heating rate 10 K/min

In order to determine the amorphous content of the component the enthalpy of crystallisation was determined using the “complex peak” method, wherein a 100% amorphous sample (obtained by atomizing) with an enthalpy of crystallisation of −47.0 J/g was used as reference.

The quotient of enthalpy of crystallisation of the component to enthalpy of crystallisation of the reference gives the percentage of the amorphous phase.

5) Determination of the elementary composition by means of emission spectrometry analysis (ICP):

An emission spectrometer Varian Vista-MPX (from the company Varian Inc.) was used. In each case two calibration samples were produced and measured for the metals from standard solutions with known metal content (for example 1000 mg/l) in aqua regia matrix (concentrated hydrochloric acid and concentrated nitric acid, in the ratio 3:1).

The parameters of the ICP device were:

power: 1.25 kW
plasma gas: 15.0 l/min (Argon)
auxiliary gas: 1.50 l/min (Argon)
atomizer gas pressure: 220 kPa (Argon)
repetition: 20 s
stabilisation time: 45 s
observation height: 10 mm
sample aspiration: 45 s
flushing time: 10 s
pump speed: 20 rpm
repetitions: 3

To measure a sample: 0.10 g+/−0.02 g of the sample were mixed with 3 ml of nitric acid and 9 ml of hydrochloric acid, as specified above, and digested in a microwave (Anton Paar, apparatus: Multiwave 3000) at 800-1200 W for 60 min. The enclosed sample was transferred with 50 vol. % hydrochloric acid into a 100 ml flask and measured.

The features of the invention disclosed in the above description, the figures and also in the claims, the flow diagram and the practical examples may be essential individually and also in any combination for the implementation of the invention in the various embodiments thereof.

1. A method for producing a component from an at least partially amorphous metal alloy, comprising the following steps:
providing a powder from an at least partially amorphous metal alloy, wherein the powder consists of spherical powder particles;
producing a shaped semi-finished product from the powder in that the powder is applied in layers and the powder particles of each newly applied layer, at least at the surface of the semi-finished product to be shaped, are fused and/or melted by targeted local heat input and bond to one another as they cool again; and
hot pressing the semi-finished product, wherein the hot pressing is performed at a temperature that is between the transformation temperature and the crystallisation temperature of the amorphous phase of the metal alloy, wherein a mechanical pressure is exerted onto the semi-finished product during the hot pressing and the semi-finished product is compacted during the hot pressing.

2. The method according to claim 1, wherein:
the hot pressing of the semi-finished product is carried out by a hot isostatic pressing of the semi-finished product, and the semi-finished product is compacted by hot isostatic pressing.

3. The method according to claim 1, wherein:
the hot pressing is performed under vacuum.

4. The method according to claim 1, wherein:
the shaped semi-finished product is produced from the powder using an additive manufacturing method.

5. The method according to claim 1, wherein:
the targeted local heat input into the powder particles of each newly applied layer is performed using an electron beam or a laser beam.

6. The method according to claim 1, wherein:
the powder particles of each newly applied layer in at least 90% of the area of the component to be produced are fused by targeted local heat input in the newly applied layer.

7. The method according to claim 1, wherein:
the powder particles have a diameter smaller than 125 μm.

8. The method according to claim 1, wherein:
the duration of the hot pressing is selected in such a way that the powder particles are bonded to one another after the hot pressing and the produced component has an amorphous content of at least 85 percent.

9. The method according to claim 1, wherein:
a powder formed from an amorphous metal alloy containing at least 50 percent by weight zirconium is used as powder.

10. The method according to claim 1, wherein:
a powder formed from an amorphous metal alloy comprising
a) 58 to 77 percent by weight zirconium,
b) 0 to 3 percent by weight hafnium,
c) 20 to 30 percent by weight copper,
d) 2 to 6 percent by weight aluminium, and
e) 1 to 3 percent by weight niobium
is provided as powder.

11. The method according to claim 1, wherein:
the powder is produced by atomizing, in a noble gas of purity 99.99% or a higher purity.

12. The method according to claim 1, wherein:
the powder comprises less than 1 percent by weight of particles with a diameter smaller than 5 μm or the powder is screened or treated by air classification, such that it comprises less than 1 percent by weight of particles with a diameter smaller than 5 μm.

13. The method according to claim 1, wherein:
the hot pressing of the powder is performed at a temperature (T) between the transformation temperature (T_{T}) and a maximum temperature, wherein the maximum temperature lies above the transformation temperature (T_{T}) by 30% of the temperature difference between the transformation temperature (T_{T}) and the crystallisation temperature (T_{K}) of the amorphous phase of the metallic alloy.

14. The method according to claim 1, wherein:
the duration of the hot pressing is selected depending on the geometric shape, of the semi-finished product, and.

15. The method according to claim 1, wherein:
the duration of the hot pressing lies in a time range of 3 seconds per millimetre of the thickness or of the greatest relevant diameter of the semi-finished product to 900 seconds per millimetre of the thickness or of the greatest relevant diameter of the semi-finished product.

16. The method according to claim 1, wherein:
the powder particles are plastically deformed by the hot pressing.

17. The method according to claim 1, wherein:
the powder particles in an inner part of a newly applied layer are not or are only partly fused and/or melted.

18. A component produced by a method according to claim 1, from a powder formed from an at least partially amorphous metal alloy.

19. (canceled)
